(19) United States
(12) Patent Application Publication
(10) Pub. No.: US 2023/0347446 A1
(43) Pub. Date: Nov. 2, 2023

(54) BATTERY POWERED CNC LASER MARKER

(71) Applicant: Panasonic Corporation of North America, Newark, NJ (US)

(72) Inventors: Carlton Brule, Boston, MA (US); Xinbing Liu, Acton, MA (US); Riccardo Leto, Arlington, MA (US)

(21) Appl. No.: 17/983,676

(22) Filed: Nov. 9, 2022

Related U.S. Application Data
(60) Provisional application No. 63/335,848, filed on Apr. 28, 2022.

(51) Int. Cl. B23K 26/362

(52) U.S. Cl. CPC B23K 26/362

(57) ABSTRACT

A wireless laser marking tool for use in a CNC machine is disclosed. The wireless laser marking tool includes a tool housing with top and bottom opposing ends, a beam delivery system between the ends, and an opening at the bottom end; a tool adapter connected to the top end of the housing for adapting the device to the CNC machine; a laser diode disposed in the beam delivery system; beam-shaping optics disposed in the beam delivery system to focus light emitted from the laser diode through the opening; electronic circuitry disposed in the beam delivery system and in electrical communication with the laser diode; a wireless communication device disposed in the beam delivery system and in electrical communication with the electronic circuitry; and a power source disposed in the beam delivery system and electrically connected to the electronic circuitry.

### CROSS REFERENCE TO RELATED APPLICATIONS

This application claims priority from U.S. Provisional Application Ser. No. 63/335,848, titled “Battery Powered CNC Laser Marker,” filed Apr. 28, 2022, incorporated herein by reference in its entirety.

### FIELD OF THE INVENTION

The present invention relates generally to laser machining systems and manufacturing apparatuses or methods. More particularly, the present invention relates to a wireless laser marking tool for use in a Computer Numerical Control (CNC) machine.

### BACKGROUND OF THE INVENTION

CNC machined parts are manufactured in a machining center using metal cutting tools, such as drills, end mills, taps, etc. If/when there is a need to mark/engrave (hereafter just “mark” for brevity) machined parts with information, e.g. manufacturing history and artistic designs or logos, the machined parts which need marking are then transferred to a separate or dedicated (standalone) marking machine, such as a laser marker, where a laser beam of sufficient power is directed upon the surface to cause a permanent change such as a burn or ablation where material is removed from the surface being irradiated. A laser marker generally requires at least the following components: a controller, a laser, and a means to generate the desired (geometrical) pattern by the laser in the part to be marked. Parts which need marking may be disposed on a motion system (e.g., a stage) while the laser beam is stationary, or a laser beam scanner may move the laser beam over the stationary part to be marked, or a combination thereof.

With use of a separate (standalone) laser marker for the marking operation, parts can be lost, misplaced, or mixed up when transferring between machines. Since each part must be precisely aligned with or positioned within the laser marker, an additional setup time is required, which increases overall manufacturing time and costs. As a conventional laser marker is a large machine, space is required on the shop floor for both machines (the CNC machine and the standalone laser marker).

Thus, wireless laser marking tools for use in a CNC machine are desired for improving laser marking of CNC machined parts, particularly as compared to having standalone machines operating separate functions.

### SUMMARY OF THE INVENTION

Aspects of the present invention are directed to laser machining systems and manufacturing apparatuses or methods. More particularly, the present invention relates to a wireless laser marking tool for use in a CNC machine.

In accordance with one aspect of the present invention, a wireless laser marking tool for use in a CNC machine is disclosed. The wireless laser marking tool comprises a tool housing with top and bottom opposing ends, a beam delivery system between the ends, and an opening at the bottom end; a tool adapter connected to the top end of the housing for adapting the device to the CNC machine; a laser diode disposed in the beam delivery system; beam-shaping optics disposed in the beam delivery system to focus light emitted from the laser diode through the opening; electronic circuitry disposed in the beam delivery system and in electrical communication with the laser diode; a wireless communication device disposed in the beam delivery system and in electrical communication with the electronic circuitry; and a power source disposed in the beam delivery system and electrically connected to the electronic circuitry.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1 depicts an exemplary system comprising a wireless laser marking tool and a CNC machine in accordance with an embodiment of the invention;

FIG. 2 depicts an exemplary wireless laser marking tool of FIG. 1 in accordance with an embodiment of the invention;

FIGS. 3A-3B depict an exemplary tool adapter of the wireless laser marking tool of FIG. 2;

FIGS. 4A-4B depicts an exemplary electronic circuitry of the wireless laser marking tool of FIG. 2;

FIG. 5 depicts an exemplary power source of the wireless laser marking tool of FIG. 2,

FIG. 6 depicts an exemplary beam-shaping optics of the wireless laser marking tool of FIG. 2;

FIG. 7 depicts an exemplary operation of the beam-shaping optics of FIG. 6;

FIG. 8 depicts performance of a battery longevity test of the laser marking tool of FIG. 2; and

FIG. 9 depicts another exemplary wireless laser marking tool in accordance with an embodiment of the invention.

### DETAILED DESCRIPTION OF INVENTION

Aspects of the invention are described herein with reference to exemplary wireless laser marking tool for use in a CNC machine. It will be understood by one of ordinary skill in the art that the exemplary tools described herein are not limited for use with a particular CNC machine, but may be applicable to other known similar devices.

The terms “workpiece” and “parts” (e.g. machined parts) as described herein and throughout the specification may encompass a variety of components formed (by a CNC machine) from a block of raw material, including but not limited to steel, aluminum, Inconel, titanium, Chrome-Molybdenum-Vanadium (CMV). Non-limiting examples of machined parts include a turbine, motor shaft, splines, etc. Likewise, the terms “information” and “pattern(s)” as described herein and throughout the specification may encompass a variety of data which may be useful for traceability of machined parts or required for a serialization process. However, laser marking is not limited to functional purposes (e.g. a QR code for providing date of manufacture, material bath, machinist, engineer, etc.), and may be additionally or optionally used for aesthetic marking, including but not limited to, artistic designs such as logos, text, images, layout patterns, etc. Still further, the term “marking” encompasses 2D cutouts, which could be used to make 3D structures, used as templates, or other applications. It should also be understood that laser marking is not limited to certain industries, which may include high value, high security industries such as aerospace and healthcare.

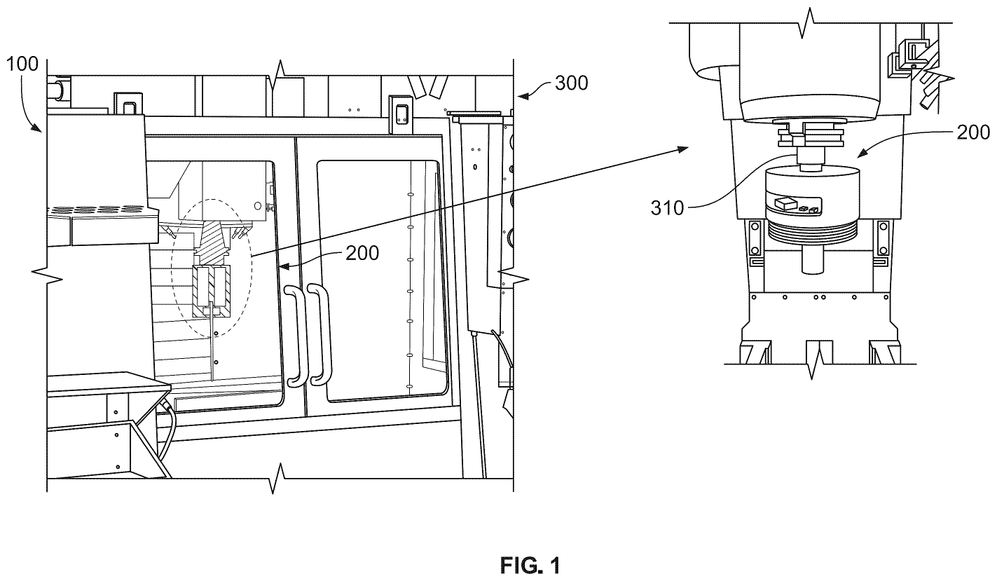

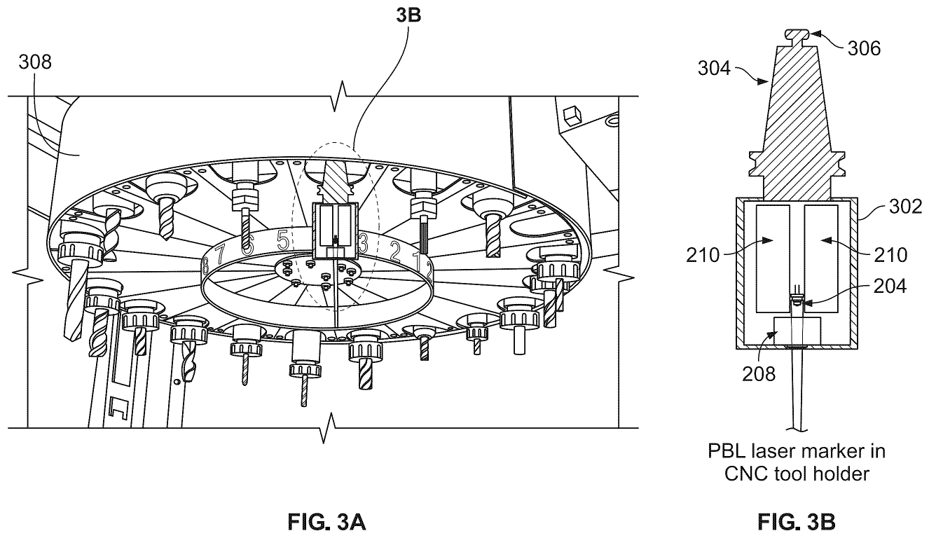

Referring now to FIG. 1, an exemplary system comprising a wireless laser marking tool and a CNC machine is depicted. In this system 100, the CNC machine comprises a CNC tool changer carousel 308 (see FIG. 3A) and spindle 310. A laser marking tool 200 is combined with the CNC machine 300, thereby improving the capabilities of the CNC machine 300 and/or eliminating the need for a separate laser marking machine. Particularly, as will be discussed further below, the laser marker tool 200 is integrated into the CNC machine 300 by mounting the tool 200 in a standard CNC tool holder 302 (see FIG. 3B). In this way, the integrated laser marking tool utilizes the CNC machine 300 to provide the precise motions needed for laser marking. In operation, synchronization and/or coordination between the laser firing of the laser marking tool 200 and the motion of the CNC machine 300 is required. Additionally, or optionally, battery management and other tasks may be required. Thus, as will be discussed further below, communication between the laser marking tool 200 and the CNC machine 300 is necessary, and this communication may be performed wirelessly or remotely.

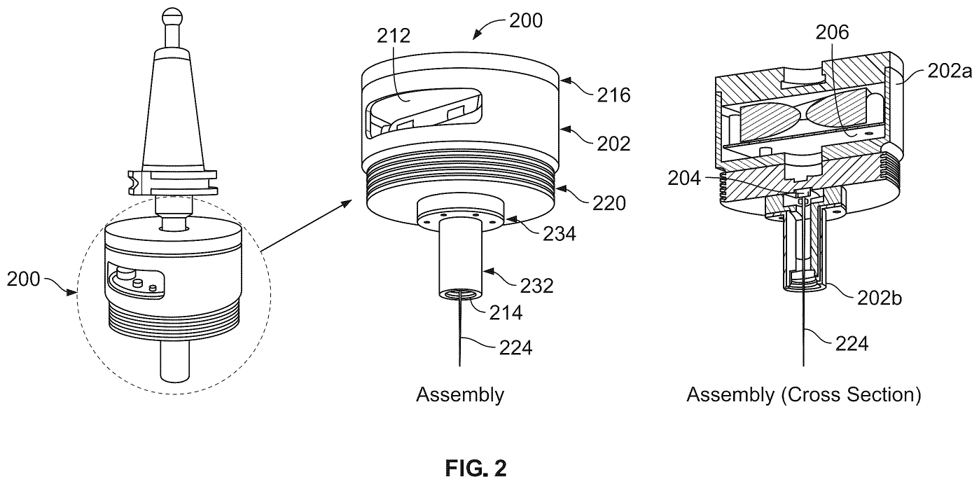

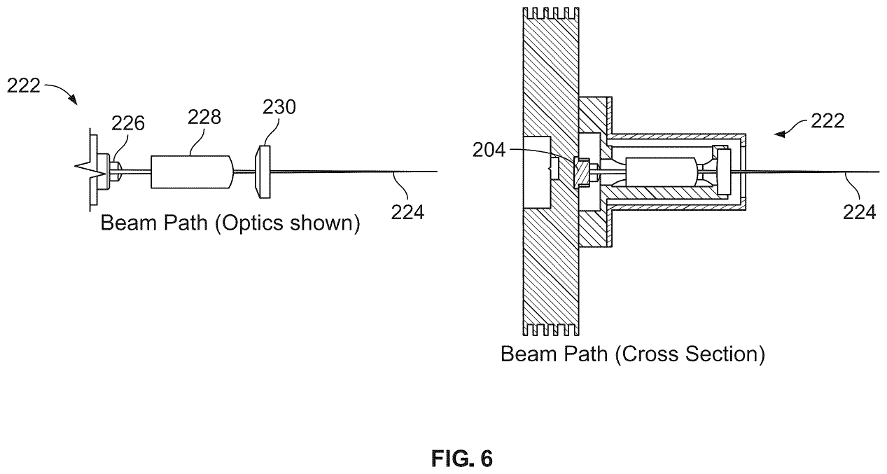

Turning now to FIGS. 2 and 3A-3B, an exemplary wireless laser marking tool for use in a CNC machine is illustrated. In general, the wireless laser marking tool 200 includes a tool housing 202, a laser diode 204 disposed within the housing 202, electronic circuitry 206 in electrical communication with the laser diode 204, a wireless communication device 208 in electrical communication with the electronic circuitry 206, and a power source 210 (e.g. a battery) electrically connected to the electronic circuitry 206. The tool housing 202 comprises a top end 202a and a bottom end 202b opposite the top end 202a. Between the two ends is a beam delivery system 212, wherein the laser diode 204, electronic circuitry 206, wireless communication device 208, and power source 210 may be disposed. Also disposed in the beam delivery system 212 is beam-shaping optics 222 (see FIG. 6) configured to focus light emitted from the laser diode 204 (e.g. laser beam path 224) through an opening 214 at the bottom end 202b of the tool housing 202. Additionally, or optionally, the bottom end 202b of housing 202 comprises an optical tube or cover 232 and/or an optical shield or mount 234 for protecting at least the laser diode 204 housed within. Still further, the wireless marking tool 200 may include one or more of a diode cap and a diode heat sink 220 for dissipating heat generated by the laser 204. In an exemplary embodiment, the wireless laser marking tool 200 is adapted to mark in gray scale.

As illustrated in FIGS. 1, 2 and 3A-3B, in order to facilitate integration of the wireless laser marking tool 200 with the CNC machine 300, a tool adapter 216 (see FIG. 2) is connected to the top end 202a of the housing 202 for adapting the laser marking tool 200 to the CNC machine 300. The tool adapter 216 is configured to engage with one or more components of CNC machine 300, such as the tool holder 302, tool carousel 308, and/or spindle 310. In an exemplary embodiment, the tool adapter 216 is integrally formed with the housing 202, such that for example, the tool adapter 216 extends from the top end 202a of the tool housing 202. Alternatively, the tool adapter 216 is a component separate from the housing 202, and may be attached or connected to the housing 202 (e.g. the top end 202a of the housing 202) by known attachment mechanisms (e.g. snap fit, adhesives, etc.). The tool holder 302 may comprise an interchangeable machine taper 304 and/or an interchangeable pull stud 306 for connecting the laser marking tool 200 to the CNC machine 300. The machine taper 304 and/or pull stud 306 may facilitate connection of the laser marking tool 200 with a CNC tool changer carousel 308 (FIG. 3A) and spindle 310 (FIG. 1). The CNC tool changer carousel 308 may comprise an automatic tool changer which include a series of standard tool holders disposed relative to each other at predetermined intervals along a circumference of tool changer carousel 308. Thus, as the tool changer rotates in response to command from a controller, having wired connections is undesirable, particularly when the individual tool holders spin or rotate at high speeds. In one non-limiting example, the machine taper 304 may comprise a spindle taper for mounting in the CNC machine 300. In this way, the wireless laser marking tool 200 is self-contained within the CNC machine 300. In an exemplary embodiment, the wireless laser marking tool 200 can be stored in the tool carousel 308 of the CNC machine 300 and can thus be used or called upon by the CNC machine 300 without interruption or requiring additional fixturing or setup or moving time (necessary when using a separate laser marker machine). Additionally, or optionally, the integration of the wireless laser marking tool 200 with the CNC machine 300 includes a security feature, wherein the machined parts to be marked or engraved cannot be removed from the CNC machine 300 until after the laser marking operation. Finally, one skilled in the art would understand that the type, shape, size, and construction of the exemplary tool holder 302 are not limited to the illustrated holders 302.

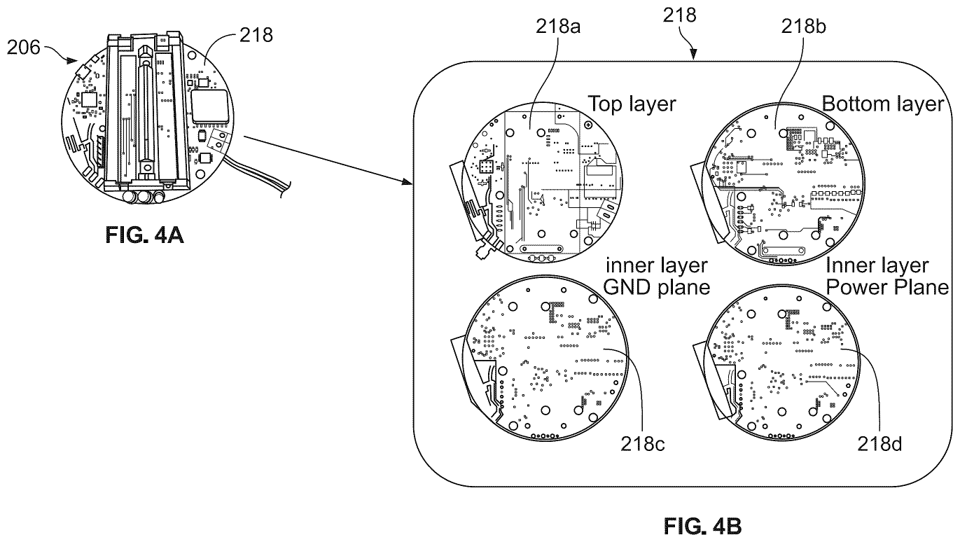

Referring now to FIGS. 3B, 4A-4B and 5, specific details of the laser operation is disclosed. As shown in FIGS. 4A-4B, exemplary electronic circuitry in electrical communication with the laser diode (FIG. 3B) is disclosed. The electronic circuitry 206 may include a printed circuit board 218 comprising a top layer 218a, bottom layer 218b, an inner layer (a GND plane, for example) 218c, and another inner layer (a power plane, for example) 218d. The laser marking tool 200 also includes a wireless communication device 208 (FIG. 3B) for facilitating coordination and/or communication between the laser marking tool 200 and a host or remote control device. In general, to facilitate wireless communication, the wireless laser marking tool 200 uses at least one of Bluetooth®, WiFi, infrared (IR), and near field communication (NFC) technology. Wireless communication would be more convenient than wired communication because the wired option would require modifications to the CNC machinery, including the CNC tool changer carousel 308 and spindle 310. Furthermore, wireless communication allows for the remote enablement or disablement of the laser marking tool 200 or a component thereof.

In an exemplary embodiment, the wireless communication device 208 provides file transfer and/or synchronization information for the laser marking of a workpiece. Optionally, the wireless laser marking tool 200 is adapted to receive a removable data storage device (e.g. SD card) for data transfer. In a non-limiting example, the synchronization information is required when the wireless laser marking tool 200 is in synchronization with the CNC motion, such that the CNC machine 300 provides motion drive to the laser marking tool 200. In a non-limiting example, synchronization may further be facilitated by an embedded motion sensor in the CNC machine 300 for synchronization. In particular, the laser marking tool 200 may comprise a Raster scan by the CNC machine 300, with synchronization of each raster line by an inertial sensor and a gyro sensor that senses spindle 310 motion. Accordingly, the wireless laser marking tool 200 is adapted to encode functions in spindle motion of the CNC machine 300. An exemplary encoded function comprises a safety interlock, such that the laser 204 is enabled only if a predetermined rotation per minute (RPM) is detected. In another exemplary embodiment, where wireless communication between the laser marking tool 200 and the remote or host control device is disabled or otherwise inoperable, thereby making synchronization between the laser marking tool 200 and the CNC machine 300 not possible, the wireless marking tool 200 uses a Vector scan by the CNC machine 300 with defocusing (Z motion) for marking a workpiece.

Importantly, the wireless laser marking tool 200 may have a laser diode 204 powered by a battery 210, which is preferable over a wired or corded laser because this wired or corded option would require modifications to the CNC tool changer carousel 308 and spindle 310. In an exemplary embodiment, the laser diode 204 may comprise a semiconductor laser. For example, the semiconductor laser is a continuous wave laser diode 204 having a wavelength of 390-470 nm and a power output of 1 W-5 W. Exemplary multi-watt blue semiconductor lasers 204 may include Metal Can® PLPT9 450LB_E Blue Laser Diode In TO-9 Package, as designed by Osram Opto Semiconductors GmbH of Regensburg, Germany. Additionally, or optionally, the laser 204 may comprise a Q-switched, diode-pumped solid-state (DPSS) laser. In one non-limiting example, the DPSS laser has the following characteristics, such as a wavelength of 1064 nm, a pulse energy (or power output) in a range between 10-5000 mW, a pulse duration in a range between 0.1-100 ns, and a pulse repetition rate in a range between 0.1-100 kHz. Additionally, or optionally, the wireless marking tool 200 includes one or more of a diode cap and a diode heat sink 220 for dissipating heat generated by the laser 204.

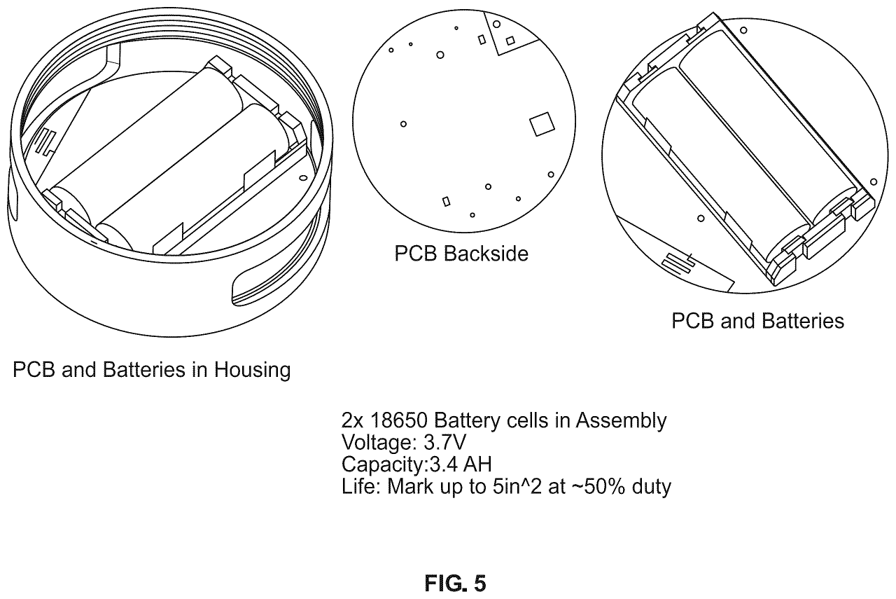

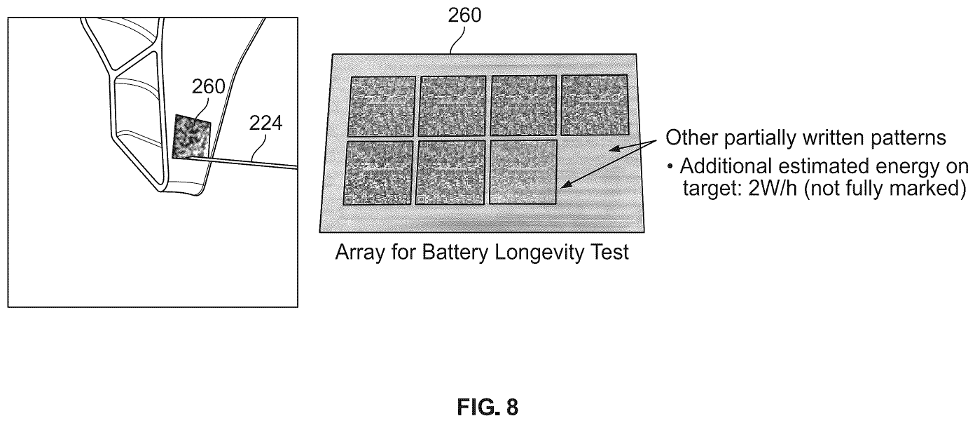

In an exemplary embodiment, as shown in FIG. 5, the battery-operated laser 204 is sufficiently powerful to mark or engrave metals to form high resolution functional and/or aesthetic patterns. Further, the battery 210 is of sufficient energy and power capacity and density, such that the battery-operated laser 204 may be housed in a small enough package so it can be installed in a standard CNC tool holder 302 for laser marking. In one non-limiting example, as shown in FIG. 8, which shows a battery longevity test as assessed based on QR code pattern 260 marked by a 5-W blue (˜450 nm) laser diode, which draws ˜13 W of power at rated output laser power. A typical Ø18 mm×65 mm (L) Li-ion rechargeable battery cell (type 18650) can have approximately 10 Whr usable capacity. So, using 2 such battery cells 210 to power the laser 204 should provide at least 1 hour laser of marking time, which is shown to be sufficient to support multiple use cycles of a laser marking tool 200 configured for forming a laser mark of a 23 mm×23 mm QR code with approximately 50% marked area (requires laser ‘ON’ duration for approximately 9 minutes). In an exemplary embodiment, battery 210 comprises a Li-ion battery cell having approximately 10 Whr capacity, such as Panasonic 18650 Li-ion 3180 mAh battery, as designed by Panasonic Energy Co. Ltd. of Japan.

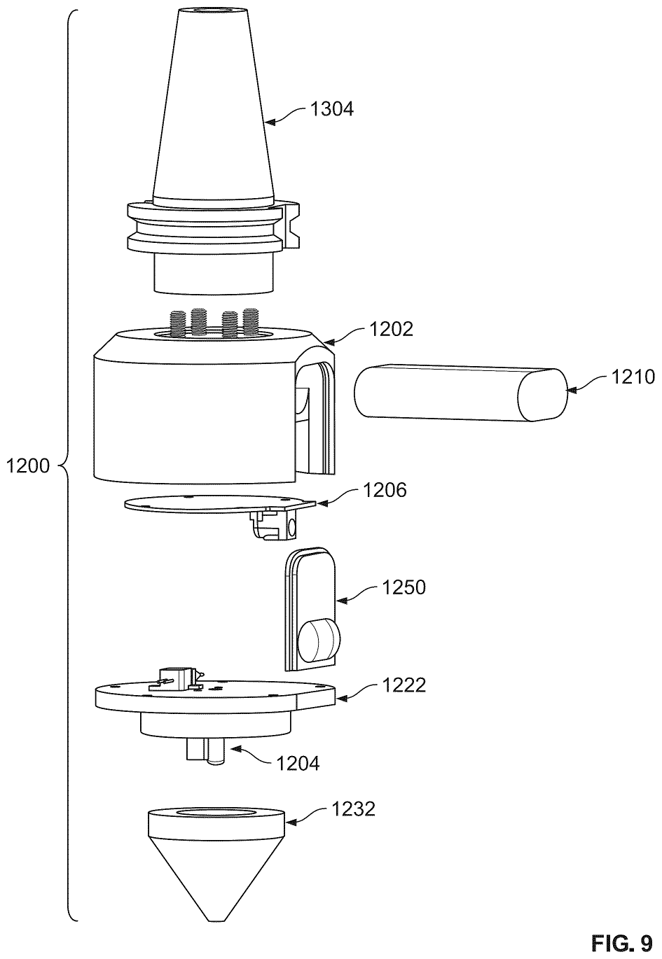

To facilitate further multiple use cycles of the laser marking tool 200, the battery 210 may be removable, such as for facilitating battery replacement. Additionally, or optionally, the battery 210 is rechargeable, and the wireless laser marking tool 200 comprises a charging port 1250 (FIG. 9) for the battery 210 and/or means for wirelessly charging the battery 210. Notably, the rechargeable battery 210 may be charged while the laser marking tool 200 is still attached to the CNC machine 300. Additionally, or optionally, the wireless laser marking tool 200 comprises built-in battery management. In an exemplary embodiment, the built-in battery management includes at least one of battery level information, a sleep mode, and a switching device. Further, laser marking tool 200 may comprise a sensor for determining if the tool 200 is mounted the CNC machine 300, such that if the tool 200 is not mounted in the CNC machine 300, the tool 200 is powered off, and when the tool 200 is mounted in the CNC machine 300, the tool 200 is powered on. In this way, battery life may be extended or improved.

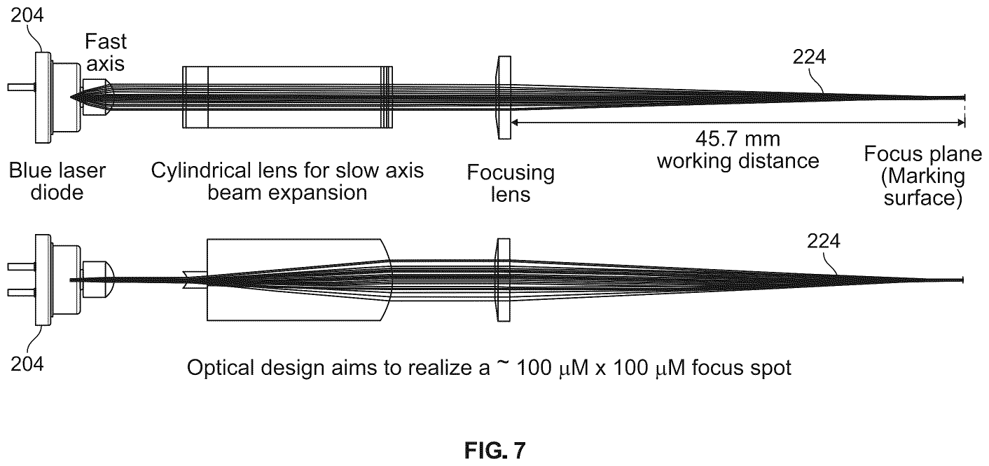

Turning now to FIGS. 6-7, an exemplary beam-shaping optics 222 is disclosed. The beam-shaping optics 222 is configured to focus light emitted from the laser diode 204 through the opening 214 at the bottom end 202b of the tool housing 202 (see FIG. 2). In an exemplary embodiment, the laser beam path 224 passes through a collimation lens 226, a cylindrical lens 228 for slow axis beam expansion, and focus lens 230. For example, this design of beam-shaping optics 222 may be configured to obtain a focused laser spot on a workpiece of marking in the range of 5 μm to 200 μm. More particularly, this design of beam-shaping optics 222 may be configured to realize a focused laser spot of approximately 100 μm by 100 μm (FIG. 7). Exemplary focus lens 230 may include SPX114AR.14 Fused Silica Plano-Convex Lens, as designed by Newport Corporation of Irvine, California. In an exemplary embodiment, the bottom end 202b of housing 202 comprises an optical tube or cover 232 and/or an optical shield or mount 234 for protecting the laser diode 204, the collimation lens 226, the cylindrical lens 228, and the focus lens 230 all housed within.

Referring to FIG. 9, another embodiment of a laser marking tool for use in a CNC machine is illustrated. The components of this embodiment, such as laser marking tool 1200, generally correspond to the components of laser marking tool 200, as described above. The wireless laser marking tool 1200 includes a tool housing 1202, a laser diode 1204 disposed within the housing 1202, electronic circuitry 1206 in electrical communication with the laser diode 1204, and a power source 1210 (e.g. a battery) electrically connected to the electronic circuitry 1206. Also disposed in the housing 1202 is beam-shaping optics 1222 configured to focus light emitted from the laser diode 1204. Also, the laser marking tool 1200 comprises an optical tube or cover, such as protective nozzle 1232, for protecting at least the laser diode 1204 housed within. Still further, in order to facilitate integration of the wireless laser marking tool 1200 with the CNC machine 300, the CNC machine 300 may comprise an interchangeable machine taper 1304 for connecting the laser marking tool 1200 to the CNC machine 300, or components thereof, e.g. CNC tool changer carousel 308 (FIG. 3A) and spindle 310 (FIG. 1). To facilitate further multiple use cycles of the laser marking tool 1200, the battery 1210 is rechargeable, and the wireless laser marking tool 1200 comprises a charging port 1250 (FIG. 9) for the battery 1210 and/or means for wirelessly charging the battery 1210.

Although the invention is illustrated and described herein with reference to specific embodiments, the invention is not intended to be limited to the details shown. Rather, various modifications may be made in the details within the scope and range of equivalents of the claims and without departing from the invention.

We claim:

1. A wireless laser marking tool for use in a Computer Numerical Control (CNC) machine, comprising:
a tool housing with top and bottom opposing ends, a beam delivery system between the ends, and an opening at the bottom end;
a tool adapter connected to the top end of the housing for adapting the laser marking tool to the CNC machine;
a laser diode disposed in the beam delivery system;
beam-shaping optics disposed in the beam delivery system to focus light emitted from the laser diode through the opening;
electronic circuitry disposed in the beam delivery system and in electrical communication with the laser diode;
a wireless communication device disposed in the beam delivery system and in electrical communication with the electronic circuitry; and
a power source disposed in the beam delivery system and electrically connected to the electronic circuitry.

2. The wireless laser marking tool according to claim 1, wherein the wireless communication device provides file transfer and/or synchronization information for the laser marking of a workpiece.

3. The wireless laser marking tool according to claim 1, wherein the wireless communication uses at least one of Bluetooth, WiFi, IR, and NFC.

4. The wireless laser marking tool according to claim 1, further comprising an embedded motion sensor in the CNC machine for synchronization of laser marking tool operation and the CNC machine motion.

5. The wireless laser marking tool according to claim 1, wherein the wireless laser marking tool is adapted to mark in gray scale.

6. The wireless laser marking tool according to claim 1, wherein the laser is a semiconductor laser.

7. The wireless laser marking tool of claim 6, wherein the semiconductor laser is a continuous wave laser diode having a wavelength of 390-470 nm and a power output of 1 W-5 W.

8. The wireless laser marking tool according to claim 1, further comprising built-in power management.

9. The wireless laser marking tool of claim 8, wherein the power management includes at least one of power level information, a sleep mode, and a switching device.

10. The wireless laser marking tool according to claim 1, wherein the laser is a Q-switched, diode-pumped solid-state (DPSS) laser.

11. The wireless laser marking too according to claim 10, wherein the DPSS laser has the following characteristics: a wavelength of 1064 nm, a pulse energy in a range between 10-5000 mW, a pulse duration in a range between 0.1-100 ns, and a pulse repetition rate in a range between 0.1-100 kHz.

12. The wireless laser marking tool according to claim 1, further comprising a spindle taper for mounting in the CNC machine.

13. The wireless laser marking tool according to claim 1, wherein the CNC machine provides motion drive to the laser marking tool.

14. The wireless laser marking tool according to claim 1, wherein the battery is removable.

15. The wireless laser marking tool according to claim 1, further comprising a charging port for the power source.

16. The wireless laser marking tool according to claim 1, further comprising means for wireless charging of the power source.

17. The wireless laser marking tool according to claim 1, further comprising a senor for determining if the tool is mounted the CNC machine, wherein if the tool in not mounted in the CNC machine the tool is powered off, and when the tool is mounted in the CNC machine the tool is powered on.

18. The wireless laser marking tool according to claim 1, wherein a focused laser spot on a workpiece of marking is in the range of 5 μm to 200 μm.

19. The wireless laser marking tool according to claim 1, wherein the wireless laser marking tool is in synchronization with the CNC motion.

20. The wireless laser marking tool according to claim 1, wherein the wireless laser marking tool is adapted to receive a removable data storage device for data transfer.

21. The wireless laser marking tool according to claim 1, further comprising Vector scan by CNC with defocusing (Z motion) for marking a workpiece.

22. The wireless laser marking tool according to claim 1, further comprising Raster scan by CNC, with synchronization of each raster line by an inertial sensor and a gyro sensor that senses spindle motion.

23. The wireless laser marking tool according to claim 22, the wireless laser marking tool being adapted to encode functions in spindle motion of the CNC machine.

24. The wireless laser marking tool according to claim 23, wherein an encoded function is a safety interlock, such that the laser is enabled only if a predetermined RPM is detected.

25. The wireless laser marking tool according to claim 1, wherein the tool adapter is integrally formed with the top end of the tool housing, such that the tool adapter extends from the top end of the tool housing.

26. The wireless laser marking tool according to claim 1, wherein the power source is a battery.
